(19) United States
(12) Patent Application Publication
(10) Pub. No.: US 2015/0037021 A1
(43) Pub. Date: Feb. 5, 2015

(54) STROBE DEVICE, AND IMAGING DEVICE PROVIDED WITH STROBE DEVICE

(71) Applicant: Panasonic Corporation, Osaka (JP)

(72) Inventor: Takashi Umehara, Osaka (JP)

(21) Appl. No.: 14/380,950

(22) PCT Filed: Feb. 26, 2013
(86) PCT No.: PCT/JP2013/001077

§ 371 Date: Aug. 26, 2014

(30) Foreign Application Priority Data
Feb. 28, 2012 (JP) 2012-041653

(51) Int. Cl. G03B 15/06; G03B 15/03; F21V 14/02

(52) U.S. Cl. CPC G03B 15/06; F21V 14/02; G03B 15/03
USPC 396/174; 362/5

(57) ABSTRACT

A strobe device of the present invention includes strobe main body, light emitting section, variable mechanism, driving section, first distance measuring section for acquiring information of the distance between strobe device and a subject, second distance measuring section for acquiring information of the distance between strobe device and a bounce surface, a distance measurement computing section for computing the bounce irradiation angle of light emitting section, and vertical angle detecting section for acquiring the angle information of light emitting section. The strobe device further includes a control device for controlling driving section so that the angle of light emitting section becomes equal to the bounce irradiation angle on the basis of the bounce irradiation angle and the angle information of light emitting section. The light emitting section can be accurately set at the bounce irradiation angle.

This application is a U.S. National Phase application of PCT International Application PCT/JP2013/001077.

### TECHNICAL FIELD

The present invention relates to a strobe device that controls an irradiation range to which a light emitting section emits light, and an imaging device including the strobe device.

### BACKGROUND ART

Conventionally, in order to obtain a natural image, an imaging device employs bounce photography where strobe light emitted from a light emitting section of a strobe device is radiated to a reflective body such as a ceiling or wall, is diffused, and indirectly illuminates a subject for photographing.

In other words, in the bounce photography, the irradiation surface of the light emitting section of the strobe device is turned to a desired direction pointing to the reflective body such as the ceiling or wall without facing the subject, the strobe light is reflected on the reflective body to illuminate the subject, and the subject is photographed.

A disclosed conventional strobe device (for example, Patent Literature 1) is configured so that a control section of the strobe device automatically controls the bounce irradiation angle between a photographing direction, namely the optical axis direction of a photographing lens, and an irradiation direction in which strobe light is radiated (desired direction pointing to the reflective body).

The strobe device of Patent Literature 1 turns the photographing lens of the imaging device toward the ceiling and subject and measures the distances to the ceiling and subject with automatic focus, and sets the bounce irradiation angle based on the distances to the ceiling and subject.

When a subject is bounce-photographed, however, the optical axis direction of the photographing lens is sometimes tilted vertically with respect to the horizontal direction. In this case, the angle of the light emitting section of a strobe device is also tilted, so that the distance between the light emitting section and a reflective body located vertically above the light emitting section cannot be measured accurately.

When bounce photography is performed in an inaccurate state of the distance to the ceiling, the bounce irradiation angle of the light emitting section that is controlled by the control section of the strobe device is inaccurate. Therefore, there are problems that the quantity of the light emitted from the light emitting section is insufficient to make a photograph dark, and the shadow of the subject appears in the photograph.

### CITATION LIST

### Patent Literature

PTL 1 Unexamined Japanese Patent Publication No. 2009-163179

### SUMMARY OF THE INVENTION

In order to address the above-mentioned problems, the present invention provides a strobe device that performs bounce photography by radiating strobe light to a bounce surface and radiating the light reflected from the bounce surface to a subject. The strobe device includes the following elements:

a strobe main body;

a light emitting section coupled to the strobe main body vertically rotatably;

a variable mechanism that can vary the angle in the vertical direction of the light emitting section;

a driving section for driving the variable mechanism;

a first distance measuring section for acquiring, as first distance information, information of the distance between the strobe device and a subject; and

a second distance measuring section for acquiring, as second distance information, information of the distance between the strobe device and a bounce surface.

The strobe device further includes the following elements:

a distance measurement computing section for computing the bounce irradiation angle in the vertical direction of the light emitting section on the basis of the first distance information and second distance information;

a vertical angle detecting section for acquiring the angle information in the vertical direction of the light emitting section; and

a control device for controlling the driving section so that the angle in the vertical direction of the light emitting section becomes equal to the bounce irradiation angle on the basis of the bounce irradiation angle and the angle information in the vertical direction of the light emitting section.

Thus, regardless of the present angle of the strobe main body or light emitting section, the control device can instantly change the angle in the vertical direction of the light emitting section to the bounce irradiation angle on the basis of the bounce irradiation angle computed by the distance measurement computing section and the angle information in the vertical direction of the light emitting section acquired by the vertical angle detecting section. As a result, the light emitting section of the strobe device can be set at an accurate bounce irradiation angle.

An imaging device of the present invention has a configuration including the strobe device.

Thus, regardless of the present angle of the strobe main body or light emitting section, the imaging device can instantly change the angle in the vertical direction of the light emitting section to the bounce irradiation angle on the basis of the bounce irradiation angle computed by the distance measurement computing section and the angle information in the vertical direction of the light emitting section acquired by the vertical angle detecting section. As a result, an imaging device that can set the light emitting section of the strobe device at an accurate bounce irradiation angle can be achieved.

### BRIEF DESCRIPTION OF DRAWINGS

FIG. 1 is a block diagram showing a configuration of an imaging device in accordance with an exemplary embodiment of the present invention.

FIG. 2 is a side view of a strobe device in accordance with the exemplary embodiment.

FIG. 3 is a top view of the strobe device in accordance with the exemplary embodiment.

FIG. 4 is a block diagram showing a configuration of the strobe device in accordance with the exemplary embodiment.

FIG. 5A is an explanatory diagram for illustrating the up-down direction (vertical direction) irradiation range capable of being set by the strobe device in accordance with the exemplary embodiment.

FIG. 5B is an explanatory diagram for illustrating the right-left direction (horizontal direction) irradiation range capable of being set by the strobe device in accordance with the exemplary embodiment.

FIG. 6A is a diagram showing the angle in the vertical direction of the light emitting section when the strobe device measures a first distance in accordance with the exemplary embodiment.

FIG. 6B is a diagram showing the angle in the vertical direction of the light emitting section when the strobe device measures a second distance in accordance with the exemplary embodiment.

FIG. 6C is a diagram showing the angle in the vertical direction of the light emitting section when the strobe device performs bounce photography in accordance with the exemplary embodiment.

FIG. 7 is an explanatory diagram showing an example of the tilt angle in bounce photographing mode of the strobe device in accordance with the exemplary embodiment.

FIG. 8 is a flowchart showing a processing procedure for manual setting of the bounce photographing mode of the strobe device in accordance with the exemplary embodiment.

FIG. 9 is a flowchart showing a processing procedure for automatic setting of the bounce photographing mode of the strobe device in accordance with the exemplary embodiment.

### DESCRIPTION OF EMBODIMENTS

A strobe device and an imaging device including the strobe device in accordance with an exemplary embodiment of the present invention will be described hereinafter with reference to the accompanying drawings. The following exemplary embodiment shows a specified example of the present invention, and does not limit the technical scope of the present invention.

### Exemplary Embodiment

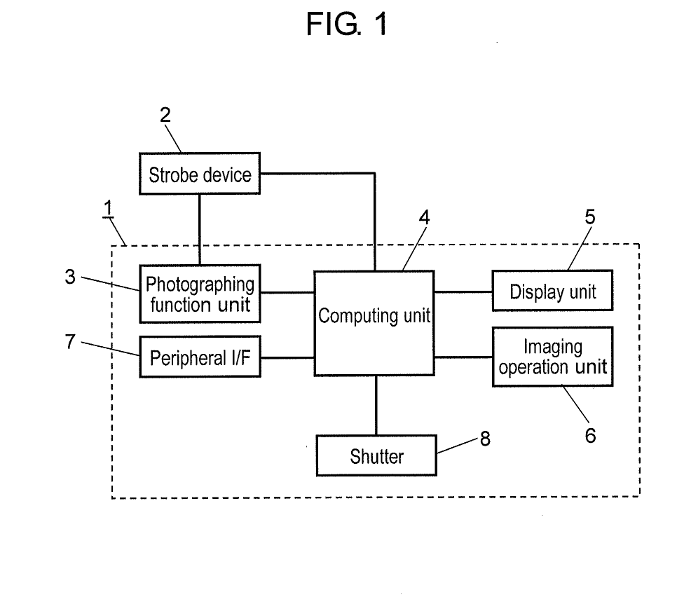

A strobe device and an imaging device including the strobe device in accordance with an exemplary embodiment of the present invention are described using FIG. 1 through FIG. 6C.

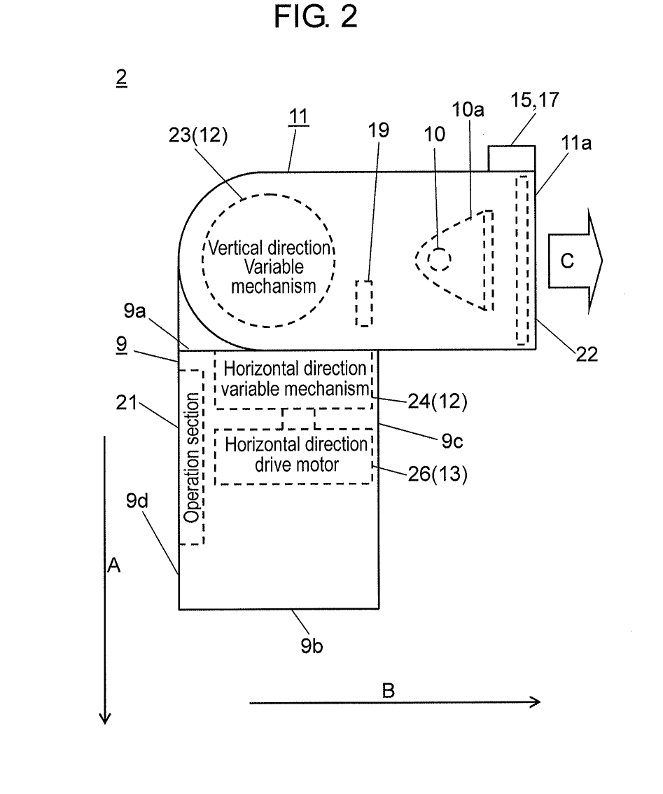

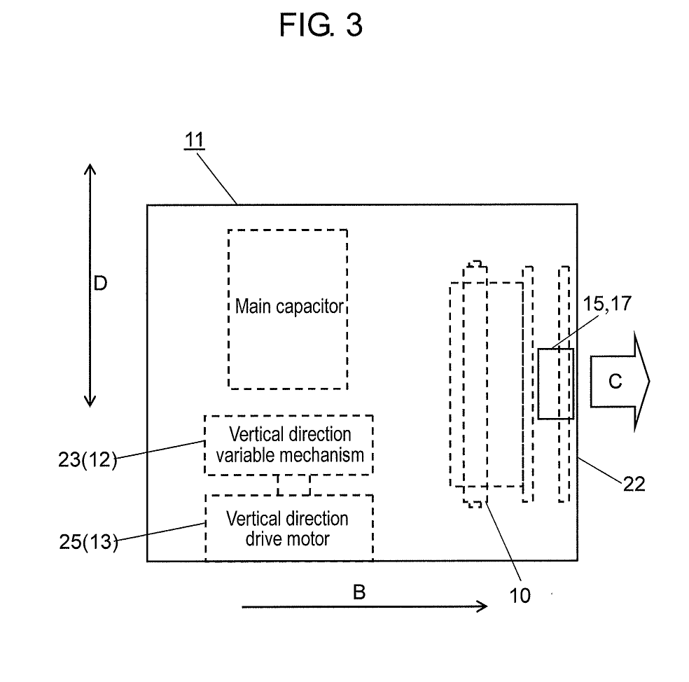

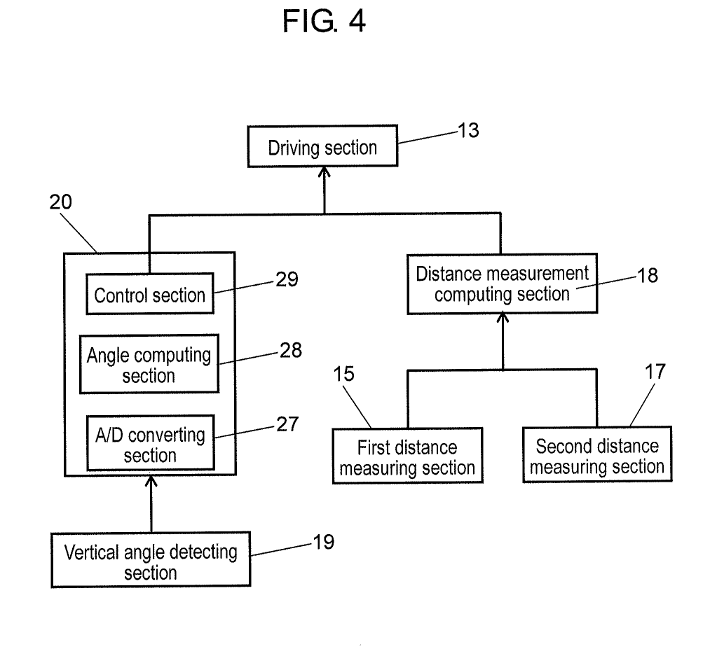

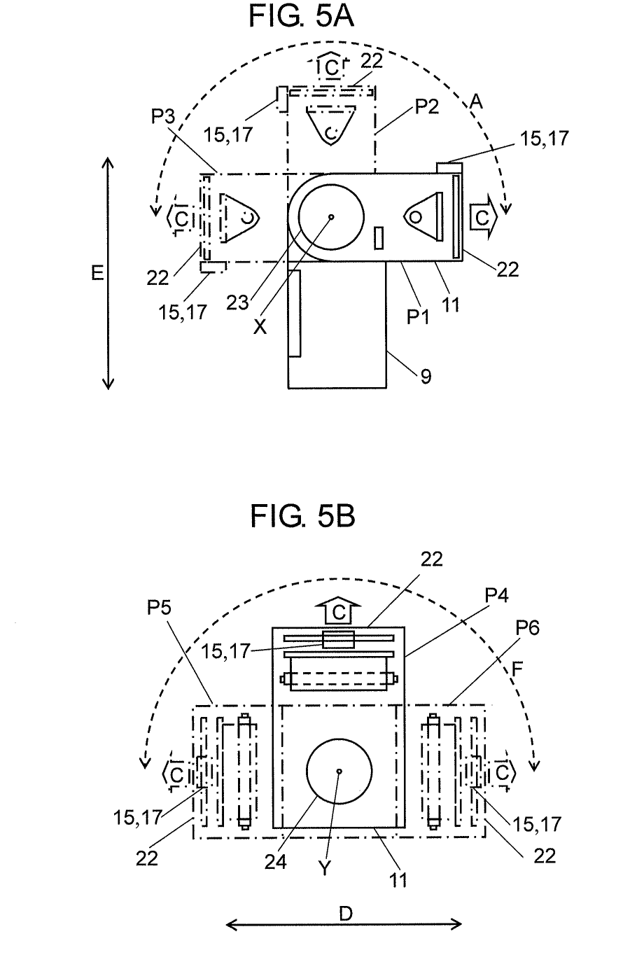

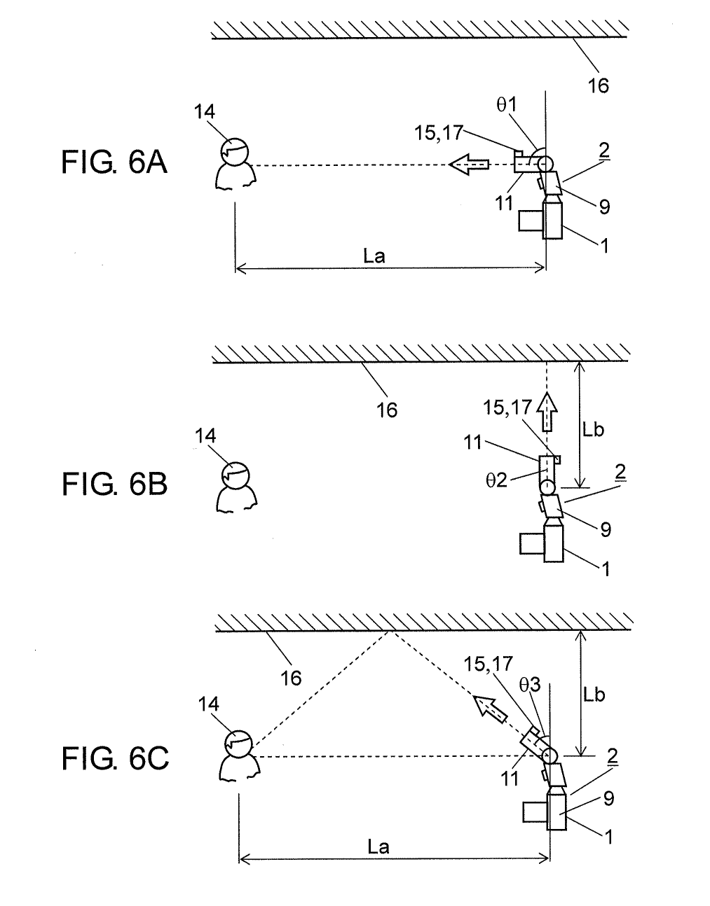

FIG. 1 is a block diagram showing a configuration of an imaging device in accordance with the exemplary embodiment of the present invention. FIG. 2 is a side view of a strobe device in accordance with the exemplary embodiment. FIG. 3 is a top view of the strobe device in accordance with the exemplary embodiment. FIG. 4 is a block diagram showing the configuration of the strobe device in accordance with the exemplary embodiment. FIG. 5A is an explanatory diagram for illustrating the up-down direction (vertical direction) irradiation range capable of being set by the strobe device in accordance with the exemplary embodiment. FIG. 5B is an explanatory diagram for illustrating the right-left direction (horizontal direction) irradiation range capable of being set by the strobe device in accordance with the exemplary embodiment. FIG. 6A is a diagram showing the angle in the vertical direction of the light emitting section when the strobe device measures a first distance in accordance with the exemplary embodiment. FIG. 6B is a diagram showing the angle in the vertical direction of the light emitting section when the strobe device measures a second distance in accordance with the exemplary embodiment. FIG. 6C is a diagram showing the angle in the vertical direction of the light emitting section when the strobe device performs bounce photography in accordance with the exemplary embodiment.

As shown in FIG. 1, imaging device 1 of the present exemplary embodiment includes at least photographing function unit 3 for imaging a subject, computing unit 4, display unit 5, imaging operation unit 6, peripheral I/F (interface) 7, and shutter 8. Strobe device 2 can be un-rotatably and detachably attached on imaging device 1. Strobe device 2 performs bounce photography by radiating strobe light to a bounce surface such as a top surface (ceiling) or wall and radiating the light reflected from the bounce surface to a subject. Here, the bounce surface is defined to be an irradiated surface such as a top surface (ceiling) or wall to which strobe light is radiated during the bounce photography.

Computing unit 4 controls strobe device 2 and photographing function unit 3. Display unit 5 displays an image obtained by imaging the subject. Imaging operation unit 6 sets the photographing condition and switches the power supply between ON and OFF. Peripheral I/F 7 transmits image data or the like between imaging device 1 and peripheral equipment. Shutter 8 is operated by a user in order to make strobe device 2 emit light to image the subject.

As shown in FIG. 2 through FIG. 4, strobe device 2 of the present exemplary embodiment includes at least strobe main body 9 formed of a casing of a rectangular shape or the like, light emitting section 11 in which flash discharge tube 10 is stored, variable mechanism 12, driving section 13, first distance measuring section 15, second distance measuring section 17, distance measurement computing section 18, vertical angle detecting section 19, control device 20, and operation section 21.

Light emitting section 11 is rotatably coupled to strobe main body 9, and flash discharge tube 10 is stored in light emitting section 11. Light emitting section 11 reflects the light emitted from flash discharge tube 10 on reflector 10a having an opening on the irradiation surface 22 side, and radiates it to the outside. Variable mechanism 12 rotates light emitting section 11 to a predetermined angle. Driving section 13 drives variable mechanism 12. First distance measuring section 15 acquires first distance La (FIG. 6A) between light emitting section 11 and subject 14. Second distance measuring section 17 acquires second distance Lb (FIG. 6B) between light emitting section 11 and the bounce surface such as top surface 16. Distance measurement computing section 18 computes the bounce irradiation angle in the vertical direction of light emitting section 11 based on first distance La and second distance Lb. Vertical angle detecting section 19 is disposed in light emitting section 11, and acquires angle information in vertical direction A (FIG. 2) of light emitting section 11. Based on a detection signal of vertical angle detecting section 19, control device 20 controls driving section 13 so that the angle in the vertical direction of light emitting section 11 becomes equal to the bounce irradiation angle. Here, driving section 13 is formed of a vertical direction drive motor (shown in FIG. 3), for example. Operation section 21 is disposed in strobe main body 9, and a user can set light emitting section 11 at a desired irradiation angle using operation section 21, for example.

Light emitting section 11 is rotatably coupled to the upper surface 9a side of strobe main body 9. Imaging device 1 of FIG. 1 can be coupled to the lower surface 9b side of strobe main body 9. At this time, lower surface 9b is coupled to imaging device 1 so that front surface 9c of strobe main body 9 points to photographing direction B (optical axis direction of a photographing lens) of imaging device 1.

Light emitting section 11 is formed of a casing of a substantially rectangular shape (including a rectangular shape), for example, and one surface 11a side of the casing includes irradiation surface 22 that radiates the light emitted from flash discharge tube 10. Light emitting section 11 is configured so that irradiation direction C of strobe light can be changed by changing the tilt angle in vertical direction A of irradiation surface 22 with variable mechanism 12.

As shown in FIG. 5A and FIG. 5B, variable mechanism 12 includes vertical direction variable mechanism 23 and horizontal direction variable mechanism 24, and rotatably couples strobe main body 9 to light emitting section 11. Specifically, vertical direction variable mechanism 23 of variable mechanism 12 is disposed rotatably in vertical direction A about rotation axis X (FIG. 5A). Rotation axis X is disposed along width direction D (FIG. 3 and FIG. 5B) of strobe main body 9. While, horizontal direction variable mechanism 24 of variable mechanism 12 is disposed rotatably in horizontal direction F about rotation axis Y (FIG. 5B). Rotation axis Y is disposed along up-down direction E (height direction: FIG. 5A) of strobe main body 9.

Furthermore, vertical direction variable mechanism 23 of variable mechanism 12 is disposed rotatably so that the angle in vertical direction A of light emitting section 11 shown by the solid line in FIG. 5A varies between the following angles:

a normal irradiation angle (the angle when light emitting section 11 exists at normal photographing position P1); and

a desired irradiation angle (the angle when light emitting section 11 exists at bounce photographing position P2 or P3) different from the normal irradiation direction angle.

Here, the desired irradiation direction angle is shown by a chain line of FIG. 5A. In this case, vertical direction variable mechanism 23 of variable mechanism 12 rotates in a rotation angle range of 180° in the vertical direction between normal photographing position P1 and bounce photographing position P3, for example.

While, horizontal direction variable mechanism 24 of variable mechanism 12 rotates in a rotation angle range of 90° (positions P5 or P6) in each of the right and left directions about position P4 of light emitting section 11 shown by the solid line in FIG. 5B.

As shown in FIG. 6A through FIG. 6C, during the bounce photography, vertical direction variable mechanism 23 can change the angle in vertical direction A of light emitting section 11 to the following angles:

(1) subject angle θ1 facing subject 14 in FIG. 6A;

(2) reflective body angle θ2 capable of facing top surface 16 located vertically above light emitting section 11 in FIG. 6B; and

(3) bounce irradiation angle θ3 for irradiating subject 14 with the light reflected on the reflective body in FIG. 6C.

At this time, the angle in vertical direction A of light emitting section 11 is changed to bounce irradiation angle θ3 by driving section 13. Driving section 13, as shown in FIG. 2 and FIG. 3, includes vertical direction driving section 25 that is formed of a vertical direction drive motor or the like and rotates and drives vertical direction variable mechanism 23, and horizontal direction driving section 26 that is formed of a horizontal direction drive motor or the like and rotates and drives horizontal direction variable mechanism 24.

Each of first distance measuring section 15 and second distance measuring section 17 is formed of a distance sensor including projection light emitting diode (LED) or position sensitive detector (PSD), for example, and is disposed in light emitting section 11. As shown in FIG. 6A, first distance measuring section 15 measures, as first distance information, distance La between light emitting section 11 and subject 14 when the angle in vertical direction A of light emitting section 11 is subject angle θ1. While, as shown in FIG. 6B, second distance measuring section 17 measures, as second distance information, second distance Lb between light emitting section 11 and top surface 16 when the angle in vertical direction A of light emitting section 11 is reflective body angle θ2. In the present exemplary embodiment, first distance measuring section 15 and second distance measuring section 17 share the same distance sensor.

Distance measurement computing section 18 is connected to first distance measuring section 15 for acquiring first distance La and second distance measuring section 17 for acquiring second distance Lb. Distance measurement computing section 18 computes bounce irradiation angle θ3 in vertical direction A of light emitting section 11 based on first distance La measured by first distance measuring section 15 and second distance Lb measured by second distance measuring section 17.

Vertical angle detecting section 19 is formed of a triaxial acceleration sensor for detecting accelerations in three directions of X, Y, and Z axes, for example, in the present exemplary embodiment. The triaxial acceleration sensor detects the gravitational acceleration during rest, and acquires, as angle information, the irradiation angle (attitude of light emitting section 11) in vertical direction A of light emitting section 11.

As shown in FIG. 4, control device 20 includes at least A/D (analog-to-digital) converting section 27, angle computing section 28, and control section 29 for controlling driving section 13. A/D converting section 27 A/D-converts the detection signal of vertical angle detecting section 19 in the present exemplary embodiment. Based on the converted value obtained by A/D converting section 27 and a specified value of the desired irradiation angle, angle computing section 28 calculates a tilt angle difference of light emitting section 11 with respect to the desired irradiation angle. Control section 29 controls driving section 13 so that the tilt angle difference of light emitting section 11 calculated by angle computing section 28 is eliminated. In other words, control device 20 changes the angle in vertical direction A of light emitting section 11 from at least the present tilt angle to bounce irradiation angle θ3.

Furthermore, control device 20 switches the photographing mode between normal photographing mode and bounce photographing mode, for example. In other words, in the normal photographing mode, control device 20 sets the tilt angle of light emitting section 11 at the normal irradiation angle so that strobe light is radiated in photographing direction B (pointing to subject 14).

While, in the bounce photographing mode, control device 20 includes the following functions:

a manual setting function of setting the tilt angle of light emitting section 11 at a desired irradiation angle so that strobe light is radiated in any direction set by the user (when indirect light is intended to be radiated to subject 14, the direction points to a reflective body having a bounce surface such as a ceiling); and

an automatic setting function of automatically setting the tilt angle of light emitting section 11 at an optimal irradiation angle.

Thus, as shown in FIG. 4, control device 20 can perform the bounce photography of pointing the irradiation direction of the strobe light of light emitting section 11 to top surface 16 as a bounce surface and of irradiating the subject 14 with the reflected light. At this time, control device 20 changes the angle in vertical direction A of light emitting section 11 to bounce irradiation angle θ3 computed by distance measurement computing section 18.

Operation section 21 is disposed on back surface 9d (opposite to the subject side) of strobe main body 9. Operation section 21 manually sets bounce irradiation angle θ3 in angle computing section 28 of control device 20 while vertical angle detecting section 19 detects the tilt angle when strobe device 2 (or only light emitting section 11) is tilted so as to point to the desired irradiation direction angle. In other words, when the user manually rotates light emitting section 11 to a desired irradiation angle, vertical angle detecting section 19 detects the angle in vertical direction A of light emitting section 11. Then, the detected value is stored, and operation section 21 sets the user desired bounce irradiation angle θ3 of light emitting section 11 and the angle in vertical direction A in association with each other.

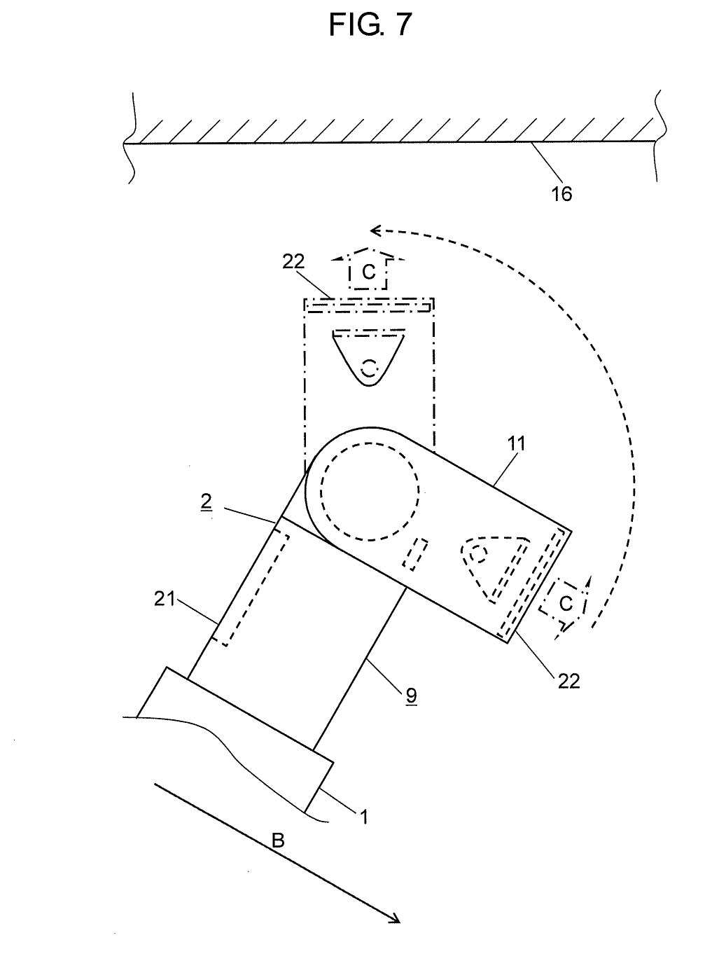

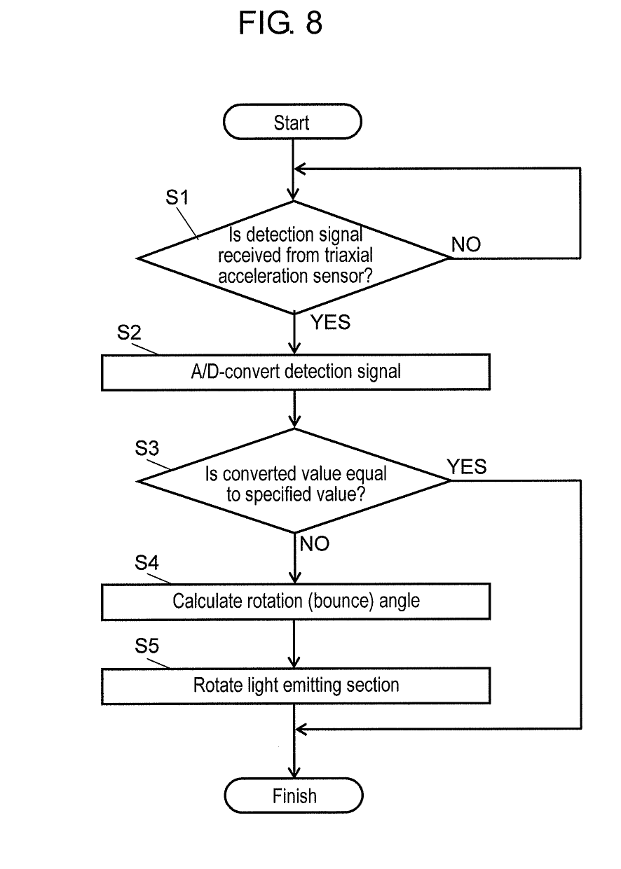

Hereinafter, in the operation of the bounce photographing mode of imaging device 1 of the present exemplary embodiment, the case where the user manually sets bounce irradiation angle θ3 is described using FIG. 7 and FIG. 8 with reference to FIG. 4.

FIG. 7 is an explanatory diagram showing an example of the tilt angle in the bounce photographing mode of the strobe device in accordance with the present exemplary embodiment.

The following case is hereinafter described: as the initial state of strobe device 2, the normal photographing mode is selected, and strobe device 2 is tilted so that irradiation direction C of light emitting section 11 of strobe device 2 points to photographing direction B as shown in FIG. 7 (corresponding to the state of normal photographing position P1 of FIG. 5A).

First, the user sets, in control device 20, bounce irradiation angle θ3 in the bounce photographing mode by the following method, as shown in FIG. 2 and FIG. 7.

Specifically, the user firstly turns irradiation surface 22 of light emitting section 11 toward top surface 16 (ceiling surface in the present exemplary embodiment) as the bounce surface to which the strobe light is radiated in the bounce photographing mode. At this time, control device 20 detects, with vertical angle detecting section 19, the angle in vertical direction A of light emitting section 11 in the above-mentioned state. Vertical angle detecting section 19 inputs a detection signal corresponding to the angle of light emitting section 11 to A/D converting section 27 of control device 20, and A/D converting section 27 A/D-converts the detection signal. A/D converting section 27 then inputs the A/D-converted value to angle computing section 28 of control device 20. Angle computing section 28 of control device 20 previously stores the converted value input from A/D converting section 27 as a specified value of bounce irradiation angle θ3 of light emitting section 11 in the bounce photographing mode.

Next, the following case is described using FIG. 8 with reference to FIG. 1 and FIG. 7. In a state where the specified value of bounce irradiation angle θ3 of light emitting section 11 is previously stored as discussed above, the user selects the bounce photographing mode and bounce-photographs a subject.

FIG. 8 is a flowchart showing a processing procedure for manual setting of the bounce photographing mode of the strobe device in accordance with the present exemplary embodiment.

First, the user presses shutter 8 while pointing the imaging lens of imaging device 1 to subject 14, thereby starting photographing. At this time, when the present angle in the vertical direction of strobe device 2 is different from the stored specified value of bounce irradiation angle θ3, light emitting section 11 is rotated to bounce irradiation angle θ3 in order to radiate the strobe light to top surface 16 (ceiling).

Specifically, first, as shown in FIG. 4 and FIG. 8, it is determined whether vertical angle detecting section 19 formed of the triaxial acceleration sensor has detected a detection signal (step S1). If vertical angle detecting section 19 has detected a detection signal (YES in step S1), the angle in vertical direction A of light emitting section 11 is detected by vertical angle detecting section 19. Then, the detection signal detected by vertical angle detecting section 19 is A/D-converted by A/D converting section 27 (step S2). If vertical angle detecting section 19 has not detected a detection signal (NO in step S1), a standby state continues until vertical angle detecting section 19 detects a detection signal.

Next, angle computing section 28 of control device 20 determines whether the converted value input from A/D converting section 27 is equal to the previously set specified value of the tilt angle corresponding to bounce irradiation angle θ3 (step S3).

At this time, if the converted value is not equal to the specified value (NO in step S3), angle computing section 28 of control device 20 calculates a rotation (bounce) angle (step S4).

Specifically, first, angle computing section 28 of control device 20 calculates the angle difference (tilt angle difference of light emitting section 11) between the converted value and the specified value of the tilt angle corresponding to bounce irradiation angle θ3.

Then, the calculated tilt angle difference is input as the rotation angle to control section 29 of control device 20.

Then, control section 29 of control device 20 rotates light emitting section 11 from the present angle by the rotation angle corresponding to the tilt angle difference (step S5).

When the tilt angle difference of light emitting section 11 is eliminated (specifically, when the converted value is equal to the specified value), the bounce processing of light emitting section 11 is completed.

If the converted value is equal to the specified value (YES in step S3), control section 29 of control device 20 completes the bounce processing of light emitting section 11 without changing the angle of light emitting section 11.

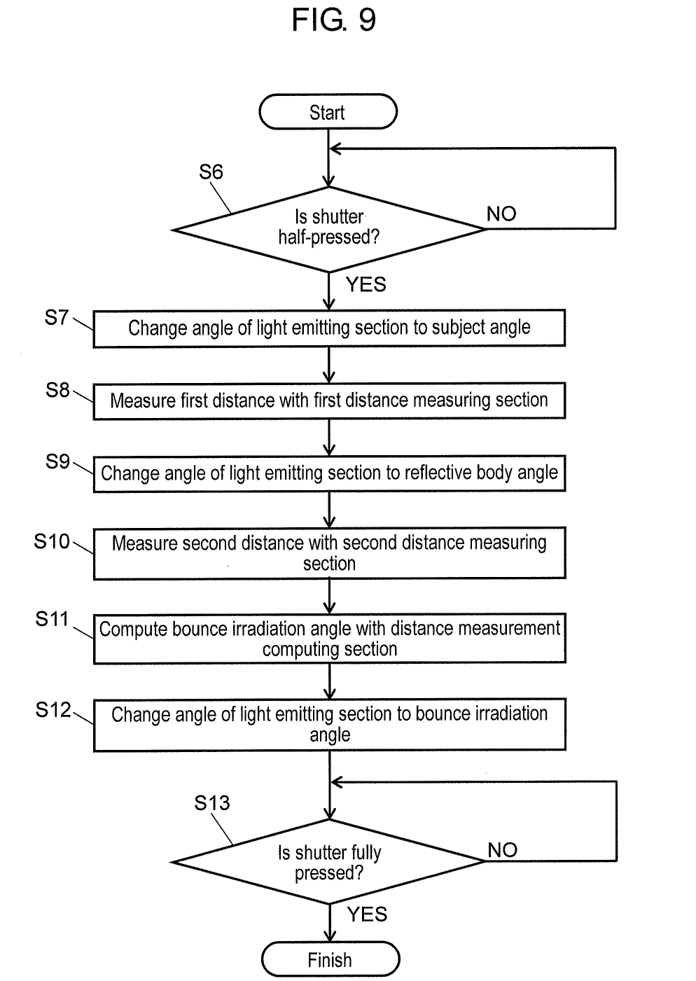

Next, the case where bounce irradiation angle θ3 is automatically set in an operation of the bounce photographing mode of imaging device 1 of the present exemplary embodiment is described using FIG. 9 with reference to FIG. 2.

FIG. 9 is a flowchart showing a processing procedure for automatic setting of the bounce photographing mode of the strobe device in accordance with the present exemplary embodiment.

First, as shown in FIG. 4 and FIG. 9, the user sets bounce irradiation angle θ3 in the bounce photographing mode of control device 20 by the following method.

Specifically, firstly, it is determined whether the user half-presses shutter 8 while pointing the optical axis of the imaging lens of imaging device 1 to a subject in the bounce photographing mode (step S6). If shutter 8 is half-pressed (YES in step S6), computing unit 4 of imaging device 1 transmits, to strobe device 2, a signal for starting the bounce photographing. If a signal indicating the half-pressing of shutter 8 is not detected (NO in step S6), a standby state continues until the signal indicating the half-pressing of shutter 8 is detected.

Next, when control device 20 of strobe device 2 receives a signal for starting the bounce photographing from computing unit 4 of imaging device 1, control device 20 drives vertical direction variable mechanism 23 with vertical direction driving section 25 to change the angle of light emitting section 11 (step S7). At this time, control device 20 changes the angle in vertical direction A of light emitting section 11 to subject angle θ1 based on the angle in vertical direction A of light emitting section 11 that is detected by vertical angle detecting section 19.

Then, when the angle in vertical direction A of light emitting section 11 is changed to subject angle θ1, first distance measuring section 15 measures first distance La between light emitting section 11 and subject 14 (step S8).

When the measurement of first distance La is completed, control device 20 drives vertical direction variable mechanism 23 with vertical direction driving section 25 to change the angle of light emitting section 11 (step S9). At this time, control device 20 changes the angle in vertical direction A of light emitting section 11 to reflective body angle θ2 based on the angle in vertical direction A of light emitting section 11 that is detected by vertical angle detecting section 19.

Then, when the angle in vertical direction A of light emitting section 11 is changed to reflective body angle θ2, second distance measuring section 17 measures second distance Lb between light emitting section 11 and top surface 16 as the bounce surface (step S10).

When the measurement of second distance Lb is completed, distance measurement computing section 18 computes bounce irradiation angle θ3 based on first distance La acquired by first distance measuring section 15 and second distance Lb acquired by second distance measuring section 17 (step S11).

Then, when the computation of bounce irradiation angle θ3 is completed, control device 20 drives vertical direction variable mechanism 23 with vertical direction driving section 25 to change the angle of light emitting section 11 (step S12). At this time, control device 20 changes the angle in vertical direction A of light emitting section 11 to bounce irradiation angle θ3 based on the angle in vertical direction A of light emitting section 11 that is detected by vertical angle detecting section 19.

In step S7 through step S12, the angle of light emitting section 11 is automatically controlled by control device 20.

Then, it is determined whether the user fully presses shutter 8 (step S13). If full pressing of shutter 8 is detected (YES in step S13), light emitting section 11 of strobe device 2 emits light to bounce-photograph subject 14. If full pressing of shutter 8 is not detected (NO in step S13), a standby state continues until the user fully presses shutter 8.

As discussed above, in the present exemplary embodiment, distance measurement computing section 18 computes bounce irradiation angle θ3 of light emitting section 11 based on first distance La acquired by first distance measuring section 15 and second distance Lb acquired by second distance measuring section 17. Then, control device 20 controls driving section 13 so that the angle in vertical direction A of light emitting section 11 becomes equal to bounce irradiation angle θ3 based on bounce irradiation angle θ3 computed by distance measurement computing section 18 and the angle information in vertical direction A of light emitting section 11 that is acquired by vertical angle detecting section 19. Thus, regardless of the present angle of light emitting section 11, the angle of light emitting section 11 can be automatically and accurately set at bounce irradiation angle θ3.

By changing the angle of light emitting section 11 with variable mechanism 12, one distance sensor can serve as both first distance measuring section 15 and second distance measuring section 17. In other words, the distance sensor can serve as first distance measuring section 15 when the angle of light emitting section 11 is changed to subject angle θ1 with variable mechanism 12. The distance sensor can serve as second distance measuring section 17 when the angle of light emitting section 11 is changed to reflective body angle θ2 with variable mechanism 12. In other words, even when light emitting section 11 includes only one distance measuring sensor, the distance between the subject and the flash discharge tube and the distance between the bounce surface and the flash discharge tube can be measured when the angle of light emitting section 11 is changed to subject angle θ1 and θ2 as shown in FIG. 6A through FIG. 6C, respectively.

In the present exemplary embodiment, regardless of the present angle of strobe device 2 (state before photographing), control device 20 can instantly change the angle of light emitting section 11 to bounce irradiation angle θ3 based on the angle in vertical direction A of light emitting section 11 that is automatically detected by vertical angle detecting section 19.

Specifically, first, control device 20 converts, with A/D converting section 27, the detection signal that is automatically detected by vertical angle detecting section 19. Angle computing section 28 of control device 20 then calculates the tilt angle difference of light emitting section 11 with respect to bounce irradiation angle θ3 based on the converted value obtained by A/D converting section 27 and the previously set specified value of the bounce irradiation angle. Control device 20 controls driving section 13 (vertical direction driving section 25 in the present exemplary embodiment) so that control section 29 eliminates the tilt angle difference of light emitting section 11 (makes the converted value equal to the specified value). Thus, a complicated processing operation in the bounce photographing mode is reduced, and the tilt angle of light emitting section 11 can be instantly changed to bounce irradiation angle θ3. As a result, the time taken for preparation for photographing is reduced, and subject 14 can be bounce-photographed without missing the photo opportunity.

In the present exemplary embodiment, by using a triaxial acceleration sensor as vertical angle detecting section 19, the tilt angle in vertical direction A of light emitting section 11 can be instantly detected. As a result, control device 20 can instantly rotate light emitting section 11 to bounce irradiation angle θ3 regardless of the present tilt angle in vertical direction A of strobe device 2.

In the present exemplary embodiment, using operation section 21, the user can previously and optionally set bounce irradiation angle θ3 in vertical direction A of light emitting section 11. Therefore, the tilt angle of light emitting section 11 can be easily changed to bounce irradiation angle θ3 set by operation section 21.

The strobe device and the imaging device including the strobe device of the present invention are not limited to those in the above-mentioned exemplary embodiment, but can be modified within the scope of the present invention.

Imaging device 1 and strobe device 2 of the present exemplary embodiment have been described using an example where first distance measuring section 15 is disposed in light emitting section 11. However, the present invention is not limited to this. For example, first distance measuring section 15 may be disposed in strobe main body 9 or imaging device 1. In this case, first distance measuring section 15 is disposed in imaging device 1 or strobe main body 9 that is un-rotatably attached on imaging device 1, and is fixed at a position where the distance to subject 14 can be always measured, so that the first distance information can be acquired. As a result, second distance measuring section 17 can acquire the second distance information without requiring the change of the angle in vertical direction A of light emitting section 11. In other words, it is not required that distances La and Lb are measured while the angle in vertical direction A of light emitting section 11 is changed up to twice, and distance Lb can be measured solely through up to one change of the angle.

Imaging device 1 and strobe device 2 of the present exemplary embodiment have been described using an example where vertical angle detecting section 19 is disposed in light emitting section 11 and detects the angle in vertical direction A of light emitting section 11. However, the present invention is not limited to this. For example, vertical angle detecting section 19 may be disposed in strobe main body 9. In this case, vertical angle detecting section 19 can detect not the tilt angle of light emitting section 11, but the angle of strobe main body 9.

Hereinafter, a specific operation in a configuration where vertical angle detecting section 19 is disposed in strobe main body 9 is described.

First, control device 20 stores, in angle computing section 28, the present tilt angle of light emitting section 11 with respect to strobe main body 9.

Then, when control device 20 calculates the rotation (bounce) angle with angle computing section 28, control device 20 calculates the angle of light emitting section 11 based on the present tilt angle of light emitting section 11 and the angle of strobe main body 9.

Then, similarly to the present exemplary embodiment, light emitting section 11 is instantly rotated to a desired irradiation angle with control section 29 of control device 20.

In other words, in the above-mentioned configuration, strobe main body 9 is fixed to imaging device 1, so that the irradiation angle is changed by rotating light emitting section 11. While light emitting section 11 is moved from the normal irradiation position to the bounce irradiation position, strobe main body 9 remains at rest, but light emitting section 11 is rotated (bounced). Since strobe main body 9 remains at rest even while the position of light emitting section 11 is changed to the bounce irradiation position, the angle of light emitting section 11 can be detected by vertical angle detecting section 19 formed of a triaxial acceleration sensor. Thus, even while the position of light emitting section 11 is changed, the angle of light emitting section 11 can be detected. As a result, the rotation (bounce) angle can be more accurately controlled.

Imaging device 1 and strobe device 2 of the present exemplary embodiment have been described using an example where operation section 21 of strobe device 2 is disposed in strobe main body 9. However, the present invention is not limited to this. For example, operation section 21 may be disposed in light emitting section 11 or imaging device 1. Thus, the degree of freedom in design of strobe device 2 or imaging device 1 can be increased.

Imaging device 1 and strobe device 2 of the present exemplary embodiment have been described using an example where strobe device 2 (or imaging device 1) and light emitting section 11 are tilted to align light emitting section 11 to bounce photographing position P2 (FIG. 5A), the angle at that time is detected by vertical angle detecting section 19, and the desired irradiation direction angle is set. However, the present invention is not limited to this. For example, a configuration may be employed where the user directly inputs the angle of light emitting section 11 using operation section 21 to set the desired irradiation direction angle. Alternatively, the desired irradiation direction angle may be previously set by control device 20.

Imaging device 1 and strobe device 2 of the present exemplary embodiment have been described using an example where the maximum rotation range of vertical direction variable mechanism 23 is 180°. However, the present invention is not limited to this. For example, the maximum rotation range of vertical direction variable mechanism 23 may be 90°. Also in this case, by combining the vertical direction variable mechanism with horizontal direction variable mechanism 24, the angle in the up-down direction (vertical direction) of light emitting section 11 can be changed from the normal irradiation position by up to 180° about rotation axis X, similarly to the present exemplary embodiment. In other words, when vertical direction variable mechanism 23 is required to be rotated in a range from 90° to 180°, this range can be achieved by configuring horizontal direction variable mechanism 24 so that it rotates by 180° in each of right and left directions.

Imaging device 1 and strobe device 2 of the present exemplary embodiment have been described using an example where vertical angle detecting section 19 detects the angle in vertical direction A of light emitting section 11 and control device 20 detects the tilt angle. However, the present invention is not limited to this. For example, a configuration may be employed where vertical angle detecting section 19 detects vertical direction A of light emitting section 11 and, based on the detection value, detects the tilt angle of light emitting section 11.

Imaging device 1 and strobe device 2 of the present exemplary embodiment have been described using an example where the irradiation direction of the strobe light is set to always point to a desired direction appropriate for the bounce photographing. However, the present invention is not limited to this. For example, the following configuration may be employed:

imaging device 1 and strobe device 2 are combined with a distance measuring sensor or a light receiving sensor for receiving the strobe light radiated from light emitting section 11, the distance measuring sensor or light receiving sensor is applied to a distance measuring section for measuring the distance to subject 14 or the bounce surface, and the irradiation direction of the strobe light is controlled so that it always points to subject 14 or the bounce surface.

Imaging device 1 and strobe device 2 of the present exemplary embodiment have been described using an example where the tilt angle of light emitting section 11 is varied with respect to strobe main body 9. However, the present invention is not limited to this. For example, a configuration may be employed where reflector 10a storing flash discharge tube 10 of light emitting section 11 shown in FIG. 2 is set to always point to a desired direction and strobe light is radiated to the bounce surface such as a ceiling.

Imaging device 1 of the present exemplary embodiment has been described using an example where strobe device 2 can be attached (detachably) to imaging device 1. However, the present invention is not limited to this. For example, a configuration may be employed where strobe device 2 is built in imaging device 1. Thus, imaging device 1 can be made to be compact.

Strobe device 2 of the present exemplary embodiment has been described using a configuration example where A/D converting section 27, angle computing section 28, and control section 29 of control device 20 are included in strobe main body 9. However, the present invention is not limited to this. For example, a part or the whole of A/D converting section 27, angle computing section 28, and control section 29 constituting control device 20 may be disposed in imaging device 1. In this case, by connecting strobe device 2 to imaging device 1, control device 20 controls strobe device 2.

Strobe device 2 of the present exemplary embodiment has been described using an example where a detection signal detected by vertical angle detecting section 19 is input to A/D converting section 27 of control device 20 and is A/D-converted. However, the present invention is not limited to this. For example, A/D converting section 27 of control device 20 may be disposed in vertical angle detecting section 19.

The imaging device of the present exemplary embodiment has been described using a configuration example where one strobe device 2 is connected to imaging device 1. However, the present invention is not limited to this. For example, a plurality of strobe devices 2 may be connected to imaging device 1. Thus, strobe light can be radiated to a plurality of bounce surfaces such as a ceiling and wall to bounce-photograph subject 14.

As discussed above, the present invention provides a strobe device that performs bounce photography by radiating strobe light to a bounce surface and radiating the reflected light from the bounce surface to a subject. The strobe device includes the following elements:

a strobe main body;

a light emitting section coupled to the strobe main body vertically rotatably;

a variable mechanism that can vary the angle in the vertical direction of the light emitting section;

a driving section for driving the variable mechanism;

a first distance measuring section for acquiring, as first distance information, information of the distance between the strobe device and a subject; and

a second distance measuring section for acquiring, as second distance information, information of the distance between the strobe device and a bounce surface.

The strobe device further includes the following elements:

a distance measurement computing section for computing the bounce irradiation angle in the vertical direction of the light emitting section on the basis of the first distance information and second distance information;

a vertical angle detecting section for acquiring the angle information in the vertical direction of the light emitting section; and

a control device for controlling the driving section so that the angle in the vertical direction of the light emitting section becomes equal to the bounce irradiation angle on the basis of the bounce irradiation angle and the angle information in the vertical direction of the light emitting section.

In this configuration, the distance measurement computing section computes the bounce irradiation angle of the light emitting section based on the first distance information acquired by the first distance measuring section and the second distance information acquired by the second distance measuring section. Regardless of the present angle of the strobe main body or light emitting section, the control device controls the driving section so that the angle in the vertical direction of the light emitting section becomes equal to the bounce irradiation angle on the basis of the bounce irradiation angle computed by the distance measurement computing section and the angle information in the vertical direction of the light emitting section acquired by the vertical angle detecting section. As a result, the light emitting section of the strobe device can be set at an accurate bounce irradiation angle.

In the strobe device of the present invention, the first distance measuring section and second distance measuring section may be disposed in the light emitting section.

In this configuration, the angle of the light emitting section can be changed by the variable mechanism. Thus, one distance measuring section can serve as both the first distance measuring section and second distance measuring section. As a result, the strobe device can be made compact, and the cost thereof can be reduced.

In the strobe device of the present invention, the first distance measuring section may acquire the first distance information in a state where the light emitting section points to the subject, and the second distance measuring section may acquire the second distance information in a state where the light emitting section points to the bounce surface.

In this configuration, by rotating, with the variable mechanism, the light emitting section to the angle at which it points to the subject, one distance measuring section can be made to serve as the first distance measuring section. By rotating, with the variable mechanism, the light emitting section to the angle at which it points to the top surface, the same distance measuring section can be made to serve as the second distance measuring section.

In the strobe device of the present invention, the first distance measuring section may be disposed in the strobe main body, and the second distance measuring section may be disposed in the light emitting section.

In this configuration, the first distance measuring section is disposed in the strobe main body of the strobe device. Thus, the first distance measuring section is fixed and disposed at a position where the distance to the subject can be always measured. As a result, the second distance measuring section can acquire the second distance information without changing the angle in the vertical direction of the light emitting section.

In the strobe device of the present invention, the control device may include the following elements:

an A/D converting section that A/D-converts a detection signal of the vertical angle detecting section;

an angle computing section that calculates a tilt angle of the light emitting section with respect to the bounce irradiation angle on the basis of the bounce irradiation angle and the converted value obtained by the A/D converting section; and

a control section that controls the driving section so that the tilt angle of the light emitting section is eliminated.

In this configuration, the control device converts, with the A/D converting section, the detection signal automatically detected by the vertical direction angle detecting section. Then, on the basis of the converted value obtained by the A/D converting section and the bounce irradiation angle value, the angle computing section of the control device calculates the tilt angle of the light emitting section with respect to the bounce irradiation angle. Thus, the control section of the control device controls the driving section so that the tilt angle of the light emitting section is eliminated. As a result, the control device can instantly change the tilt angle of the light emitting section.

In the strobe device of the present invention, the vertical angle detecting section may be formed of a triaxial acceleration sensor.

In this configuration, the triaxial acceleration sensor can detect the angle in the vertical direction of the light emitting section. Thus, the control device can instantly rotate the light emitting section to the bounce irradiation angle in the vertical direction regardless of the present angle in the vertical direction of the strobe device.

In the strobe device of the present invention, the vertical angle detecting section is disposed in one of the strobe main body and light emitting section.

In this configuration, the degree of freedom in design of the strobe device can be increased.

The imaging device of the present invention has a configuration including the strobe device.

In this configuration, the distance measurement computing section computes the bounce irradiation angle based on the first distance information acquired by the first distance measuring section and the second distance information acquired by the second distance measuring section. Regardless of the present angle of the strobe main body or light emitting section, the distance measurement computing section controls the driving section so that the angle in the vertical direction of the light emitting section becomes equal to the bounce irradiation angle on the basis of the bounce irradiation angle computed by the distance measurement computing section and the angle information in the vertical direction of the light emitting section acquired by the vertical angle detecting section. As a result, an imaging device capable of setting the light emitting section of the strobe device at an accurate bounce irradiation angle can be achieved.

The imaging device of the present invention may have the following configuration: the first distance measuring section is disposed in the imaging device, and acquires, as first distance information, information of the distance between the imaging device and the subject; and the second distance measuring section is disposed in the light emitting section, and acquires, as second distance information, information of the distance between the light emitting section and the bounce surface.

In this configuration, the first distance measuring section is disposed in the imaging device. Thus, the first distance measuring section is fixed and disposed at a position where the distance to the subject can be always measured. The second distance measuring section can acquire the second distance information without changing the angle in the vertical direction of the light emitting section. As a result, an imaging device capable of setting the light emitting section of the strobe device at an accurate bounce irradiation angle can be achieved.

### INDUSTRIAL APPLICABILITY

In the present invention, the irradiation direction of strobe light is instantly changed from the present irradiation direction to a desired irradiation direction, and the bounce irradiation angle at which a light emitting section irradiates the bounce surface can be accurately set. The present invention is useful for a strobe device that requires bounce photography of photographing a subject without missing the photo opportunity, and is useful for an imaging device including the strobe device.

### REFERENCE MARKS IN THE DRAWINGS

1 imaging device
2 strobe device
3 photographing function unit
4 computing unit
5 display unit
6 imaging operation unit
8 shutter
9 strobe main body
9a upper surface
9b lower surface
9c front surface
9d back surface
10 flash discharge tube
10a reflector
11 light emitting section
11a one surface
12 variable mechanism
13 driving section
14 subject
15 first distance measuring section
16 top surface (bounce surface)
17 second distance measuring section
18 distance measurement computing section
19 vertical angle detecting section
20 control device
21 operation section
22 irradiation surface
23 vertical direction variable mechanism
24 horizontal direction variable mechanism
25 vertical direction driving section
26 horizontal direction driving section
27 A/D converting section
28 angle computing section
29 control section

1. A strobe device for performing bounce photography by radiating a strobe light to a bounce surface and radiating a reflected light from the bounce surface to a subject, the strobe device comprising:
a strobe main body;
a light emitting section coupled to the strobe main body vertically rotatably;
a variable mechanism capable of varying an angle in a vertical direction of the light emitting section;
a driving section for driving the variable mechanism;
a first distance measuring section for acquiring, as first distance information, information of a distance between the strobe device and the subject;
a second distance measuring section for acquiring, as second distance information, information of a distance between the strobe device and the bounce surface;
a distance measurement computing section for computing a bounce irradiation angle in the vertical direction of the light emitting section on the basis of the first distance information and the second distance information;
a vertical angle detecting section for acquiring angle information in the vertical direction of the light emitting section; and
a control device for controlling the driving section so that the angle in the vertical direction of the light emitting section becomes equal to the bounce irradiation angle on the basis of the bounce irradiation angle and the angle information in the vertical direction of the light emitting section.

2. The strobe device of claim 1, wherein
the first distance measuring section and the second distance measuring section are disposed in the light emitting section.

3. The strobe device of claim 2, wherein
the first distance measuring section acquires the first distance information in a state where the light emitting section points to the subject, and
the second distance measuring section acquires the second distance information in a state where the light emitting section points to the bounce surface.

4. The strobe device of claim 1, wherein
the first distance measuring section is disposed in the strobe main body, and the second distance measuring section is disposed in the light emitting section.

5. The strobe device of claim 1, wherein
the control device comprising:
an A/D converting section for A/D-converting a detection signal of the vertical angle detecting section;
an angle computing section for calculating a tilt angle of the light emitting section with respect to the bounce irradiation angle on the basis of the bounce irradiation angle and a converted value obtained by the A/D converting section; and
a control section for controlling the driving section so that the tilt angle of the light emitting section is eliminated.

6. The strobe device of claim 1, wherein
the vertical angle detecting section is formed of a triaxial acceleration sensor.

7. The strobe device of claim 1, wherein
the vertical angle detecting section is disposed in one of the strobe main body and the light emitting section.

8. An imaging device comprising the strobe device of claim 1.

9. The imaging device of claim 8, wherein
a first distance measuring section is disposed in the imaging device, and acquires, as first distance information, information of a distance between the imaging device and a subject, and
a second distance measuring section is disposed in a light emitting section, and acquires, as second distance information, information of a distance between the light emitting section and a bounce surface.
